(19) United States
(12) Patent Application Publication
(10) Pub. No.: US 2024/0014408 A1
(43) Pub. Date: Jan. 11, 2024

(54) OXYGEN EVOLUTION CATALYST, PRODUCTION AND USE THEREOF, MEMBRANE ELECTRODE ASSEMBLY, AND FUEL CELL OR ELECTROLYSIS CELL

(71) Applicants: Greenerity GmbH, Akzenau (DE); Technische Universität München, München (DE)

(72) Inventors: Mohammad Fathi Tovini, München (DE); Jens-Peter Suchsland, Alzenau (DE); Hany Elsayed, Neufahrn (DE); Ana Marija Damjanovic, München (DE); Frédéric Hasché, Berlin (DE); Hubert Gasteiger, München (DE); Jozsef Speder, Frankfurt am Main (DE)

(21) Appl. No.: 18/030,786

(22) PCT Filed: Oct. 7, 2021
(86) PCT No.: PCT/EP2021/077752

§ 371 Date: Apr. 7, 2023

(30) Foreign Application Priority Data
Oct. 13, 2020 (DE) 10 2020 126 795.9

(51) Int. Cl. H01M 4/90; H01M 8/1004

(52) U.S. Cl. CPC H01M 4/9016; H01M 8/1004; H01M 2004/8684

(57) ABSTRACT

An oxygen evolution reaction catalyst includes a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, the BET specific surface area of the solid solution is greater than 10 m²/g, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

### TECHNICAL FIELD

This disclosure relates to an oxygen evolution reaction catalyst, production and use thereof and a membrane electrode assembly, a fuel cell and an electrolysis cell containing this oxygen evolution reaction catalyst.

### BACKGROUND

During operation of a fuel cell an insufficient amount of fuel coupled with simultaneous demand of a certain current can result in high potentials of, for example, 1.4 V or more occurring on the anode of a membrane electrode assembly (MEA), thus reversing the voltage of the fuel cell. This phenomenon is commonly referred to as “fuel starvation” or “cell reversal.” Under such high potentials the carbon typically used in the anodes as support material for catalysts oxidizes (corrodes) and the MEA degrades.

It is also known that a carbon oxidation reaction (COR) during fuel starvation can be avoided in the anode by addition of oxygen evolution reaction catalysts (OER catalyst) since this ensures that during fuel starvation oxygen evolution from water is favored over carbon oxidation. Iridium dioxide (IrO₂) and ruthenium dioxide (RuO₂) are currently considered to be the best OER catalysts in acidic media. However, a disadvantage of IrO₂ and RuO₂ is that they can easily be reduced to metallic iridium and metallic ruthenium under the conditions of the anode of a fuel cell since the reduction of these noble metal oxides by hydrogen can occur spontaneously at the operating temperature of the fuel cell. The operating temperature is typically around 80° C. Dissolution of metallic iridium and ruthenium to form cationic compounds can also occur. Accordingly the use of OER catalysts to avoid COR in fuel cells can lead to dissolution of the OER catalyst and thus to ionic contamination of the membrane and the cathode catalyst layer especially under startup/shutdown (SUSD) operating conditions and to fuel starvation, thus resulting in a reduction in the power density of the MEA. This reduction in power density is attributable to the reduction of IrO₂ and RuO₂ by hydrogen.

Furthermore, OER catalysts containing valve metal oxides such as, for example, titanium dioxide, niobium oxide, tungsten oxide and tantalum oxide which under the operating conditions of the PEMFC are not reducible and insoluble in acidic media are known. However, when combined with iridium oxide or ruthenium oxide these OER catalysts do not exhibit a sufficiently high reduction stability towards hydrogen. This is thought to be attributable to the catalyst structure by which, for example, iridium oxide or ruthenium oxide are supported or co-deposited on a valve metal oxide, thus affording a composite structure or partial solid solutions.

It could therefore be helpful to provide an oxygen evolution reaction catalyst featuring very good stability towards reduction by hydrogen coupled with high catalytic activity, a process of producing, and a use of, the oxygen evolution reaction catalyst, a membrane electrode assembly and a fuel cell and also an electrolysis cell containing this oxygen evolution reaction catalyst, wherein the MEA and the fuel cell and also the electrolysis cell feature enduringly high power density even in fuel starvation or under startup/shutdown conditions.

### SUMMARY

We provide an oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, the BET specific surface area of the solid solution is greater than 10 m²/g, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

We also provide an anode for a fuel cell including an oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

We further provide an anode for an electrochemical cell including the oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, the BET specific surface area of the solid solution is greater than 10 m²/g, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

We further yet provide a membrane electrode assembly including the anode for a fuel cell including an oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

We also further provide a water electrolysis including an anode for an electrochemical cell including the oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, the BET specific surface area of the solid solution is greater than 10 m²/g, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

We also further provide a fuel cell including the anode for a fuel cell including an oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

We also further provide a process of producing the oxygen evolution reaction catalyst including a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, the BET specific surface area of the solid solution is greater than 10 m²/g, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours, including a) heat treating an oxide of iridium and/or an oxide of ruthenium and/or mixtures of these oxides and/or alloys thereof and at least one valve metal oxide selected from oxides of titanium, oxides of niobium, oxides of tungsten and oxides of tantalum at a temperature of at least 900° C. to obtain a solid solution of at least one valve metal oxide and at least one noble metal oxide, b) grinding the obtained solid solution, and c) heat treating the ground solid solution at a temperature of 250° C. to 500° C.

### BRIEF DESCRIPTION OF THE DRAWINGS

FIG. 1 shows a process of producing OER catalysts.

FIG. 2 shows test results of TGA ramp experiments.

FIGS. 3a and 3b show test results of TGA ramp experiments.

FIG. 4 shows test results of TGA ramp experiments.

FIG. 5 shows test results according to isothermal mode.

FIG. 6 shows an XRD pattern.

FIGS. 7a-7d show test results of TGA ramp experiments and experiments according to isothermal mode.

FIG. 8 shows MEA performance losses.

### LIST OF REFERENCE NUMERALS

1 Iridium compound precursor
2 Valve metal oxide
3 Iridium oxide
4 OER catalyst
5 Valve metal oxide precursor
6 OER catalyst having composite structure
7 Mixture of oxide of Ir and/or oxide of Ru
8 Valve metal oxide
9 Solid solution
10 Ground solid solution
11 OER catalyst
12 OER catalyst
13 Carrier material
a), b), b2), c) Process steps

### DETAILED DESCRIPTION

Our oxygen evolution reaction catalyst comprises a solid solution of at least one valve metal oxide and at least one noble metal oxide. A solid solution means a complete, i.e., a real solid solution, and not only a partial solid solution such as is known. The difference is in the crystallinity of the solid solution and may be confirmed by x-ray diffraction. In other words, our crystal structure of our solid solution differs from known solid solutions. In particular, the XRD patterns show no peaks for the valve metal oxides themselves nor for the noble metal oxides themselves. Exclusively peaks of the solid solution are obtained, as is apparent not only from their peak pattern but also from the angles that are distinct from the starting compounds. A real solid solution is thus easily distinguishable from partial solid solutions by x-ray diffraction as elucidated in detail below.

To produce the solid solution a mixture of valve metal oxide(s) and noble metal oxide(s) determined according to a phase diagram is employed, this too promoting formation of a real solid solution having characteristic x-ray diffraction peaks during acquisition of x-ray diffraction spectra.

The valve metal oxide is selected from oxides of titanium, oxides of niobium, oxides of tungsten and oxides of tantalum and the noble metal oxide is selected from oxides of iridium, oxides of ruthenium and/or mixtures and/or alloys thereof.

Furthermore, the BET specific surface area of the solid solution is greater than 10 m²/g. The specific surface area is determined by nitrogen adsorption (BET method). The “BET specific surface area of the solid solution” means the BET specific surface area of the catalytically active material of the OER catalyst. In other words, the BET specific surface area relates exclusively to the solid solution present in the OER catalyst and explicitly not to any support materials or supported OER catalysts. The BET specific surface area is measured in m²_{solid solution}/g_{solid solution}. The BET surface area is determined using a Quantachrome Autosorb iQ instrument. The samples are degassed overnight at 120° C. and the N₂-Adsorption is measured at 77 K. The specific surface area (BET specific surface area) is determined according to Brunauer-Emmett-Teller (BET) theory using “mircopore BET assistant” of the software AsiQwin. The upper limit of the BET-specific surface area of the oxygen evolution reaction catalyst is not specifically limited but is preferably not more than 150 m²/g for reasons of simplified production of such a surface area.

When the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours. This means in other words that our OER catalyst exhibits a high stability towards reduction in a hydrogen-containing atmosphere. The catalyst retains its OER activity during use, for example, in a fuel cell anode even under potential cycles such as those occurring during startup/shutdown events on account of its stability in a reductive environment. On account of this property of the good OER activity of the OER catalyst remains unchanged and the fuel cell is efficiently protected from carbon corrosion during undesired cell reversal events.

The reduction stability of the OER catalyst is determined by measuring the mass loss/weight loss of the OER catalyst under the influence of a hydrogen flow at elevated temperature. To this end, a thermogravimetric analysis (TGA) is carried out in a reductive atmosphere. The thermogravimetric analysis of the OER catalyst powder is performed using a Mettler Toledo TGA/DSC 1 apparatus. About 10 to 12 mg of the OER catalyst in powder form are placed in a corundum crucible (volume: 70 μL) and sealed with a perforated corundum lid and placed directly in the TGA furnace. All gases used in the thermogravimetric analysis are of 5.0 purity and obtainable from Westfalen AG. Argon (20 mLmin⁻¹) is used as a cell carrier gas in addition to hydrogen.

Each TGA measurement is divided into steps:
i) in-situ drying step in oxidizing atmosphere, and
ii) metal oxide reduction step in reducing atmosphere.

The in-situ drying step is used to desorb all water molecules and organic molecules adsorbed on the surface of the OER catalyst powder to ensure that the weight loss in step ii) is due only to the reduction of the noble metal oxide. The valve metal oxide is stable to reduction under these reaction conditions.

The in-situ drying step is performed as follows: initially the TGA furnace is purged with argon for 5 min at a temperature of 25° C. (100 mLmin⁻¹), subsequently the temperature is increased from 25° C. to 200° C. (10 Kmin⁻¹) in O₂ (100 mLmin⁻¹). The temperature of 200° C. is held for 10 min in O₂ (100 mLmin⁻¹). The furnace is then cooled from 200° C. to 25° C. (−10 Kmin⁻¹) in O₂ (100 mLmin⁻¹) and finally the TGA furnace is purged with argon (100 mLmin⁻¹) for 5 min at 25° C.

The metal oxide reduction step (noble metal oxide reduction step) is performed according to two different modes: a) a temperature ramp mode, and b) an isothermal mode, wherein the temperature ramp mode is used to confirm the result of the isothermal mode and the isothermal mode determines the actual reduction stability.

Depending on the employed noble metal (iridium and/or ruthenium) different temperature ramps are run when performing step in the temperature ramp mode. The temperature of the furnace is increased from 25° C. to 500° C. if iridium is present as noble metal and from 25° C. to 800° C. if ruthenium is present as noble metal in the absence of iridium at a heating rate of 5 Kmin⁻¹ in 3.3 vol % H₂/Ar (40 mLmin⁻¹) followed by cooling of the furnace to 25° C. (cooling rate: −20 Kmin⁻¹) in argon (100 mLmin⁻¹).

When performing the step in the isothermal mode the furnace is heated from 25° C. to 80° C. at a heating rate of 5 Kmin⁻¹ in argon (100 mLmin⁻¹) followed by gas switchover to 3.3 vol % H₂/Ar (40 mLmin⁻¹) and held at 80° C. for 12 hours. Thereafter the furnace is cooled from 80° C. to 25° C. (cooling rate: −20 Kmin⁻¹) in Ar (100 mLmin⁻¹). To determine the reduction stability of the OER catalyst the metal oxide reduction step according to b), i.e., the isothermal mode, is performed as specified above. A temperature ramp mode (temperature ramp experiment) giving the same results can be used to confirm the obtained results according to the isothermal mode.

An extraordinarily high reduction stability is achieved through a weight loss of less than 2% by weight according to the abovementioned methods and an enduringly high catalytic activity is obtained due to the simultaneously high BET specific surface area of more than 10 m²/g.

Due to the very good reduction stability of the OER catalyst the noble metal oxide of the OER catalyst is not reduced to metallic noble metal by hydrogen during fuel cell operation and accordingly shows no dissolution or conversion into contaminating noble metal compounds during startup/shutdown cycles and/or cell reversal conditions. This stability has two consequences: on the one hand the OER activity is retained during operation of an electrochemical cell, thus retaining a cell reversal tolerance over the complete lifetime of an MEA, and on the other hand the reduction stability prevents formation of metallic noble metal and consequent formation of noble metal ions which can contaminate the MEA, thus retaining enduringly good power density.

Simultaneously, the very high BET specific surface area of the OER catalyst ensures a sufficiently high OER activity of the catalyst, wherein the OER activity prevents carbon corrosion due to high potentials that occur in cell reversal during fuel starvation.

To improve the catalytic activity of the OER catalyst of the BET specific surface area of the solid solution is more than 20 m²/g.

Advantageously, we provide that the oxygen evolution reaction catalyst is supported on a support material to stabilize the BET specific surface area thus to obtain the highest possible catalytic activity. Supporting the OER catalyst prevents agglomeration thereof. Suitable support materials especially include electrically conductive support material such as in particular carbon-based support materials including especially graphitized carbon or acetylene-based carbon.

Also, we provide a first anode for a fuel cell comprising an oxygen evolution reaction catalyst comprising a solid solution of at least one valve metal oxide and at least one noble metal oxide, wherein the valve metal oxide is selected from oxides of titanium, oxides of niobium, oxides of tungsten and oxides of tantalum and wherein the noble metal oxide is selected from oxides of iridium, oxides of ruthenium and/or mixtures and/or alloys thereof. The oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

Having regard to the definitions and measurements for the solid solution and the reduction stability reference is made to the foregoing in relation to the OER catalyst.

We also provide a second anode comprising the OER catalyst.

Due to the use of the respective OER catalyst in the first anode and in the second anode the first and the second anode also feature very good stability and very good tolerance to cell reversal in fuel starvation and also high degradation stability under startup/shutdown conditions.

Advantageously, in particular if our anode is used as an anode of a fuel cell, the anode advantageously comprises at least one hydrogen oxidation catalyst. The hydrogen oxidation catalyst is preferably a platinum-based hydrogen oxidation catalyst that exhibits very good corrosion resistance on account of its noble metal character.

The OER catalyst may be present in the anode in supported or unsupported form. This also applies to the hydrogen oxidation catalyst. Further advantageously, the hydrogen oxidation catalyst is supported on a support material and/or on the oxygen evolution reaction catalyst. In a first example, this means that both the hydrogen oxidation catalyst and the OER catalyst are arranged on a support material such as in particular a carbon-based support material and especially graphitized carbon. The respective carrier materials may be the same or different. The OER catalyst and the hydrogen oxidation catalyst are preferably supported on the same support material. To this end, an OER catalyst may, for example, be supported on a support material and subsequently blended with a hydrogen oxidation catalyst. This may result in the hydrogen oxidation catalyst being preferentially deposited on the OER catalyst already deposited on the support material. In a further example, the OER catalyst and the hydrogen oxidation catalyst may be blended with one another and then supported on a support material. This may result in both the OER catalyst and the hydrogen oxidation catalyst being supported on the support material. This has the advantage that it is possible to use a small amount of support material relative to the catalytically active substances, thus having a positive effect on corrosion resistance and cell reversal tolerance. The two catalysts may also be present in supported form independently of one another on the same or different support materials. It is also possible for one of the catalysts to be present on the respective other catalyst. The final structure depends on the mixing ratios and quantity ratios of the employed catalysts.

We also provide a membrane electrode arrangement, a water electrolysis cell and a fuel cell. They contain the first and/or second anode as described above and on account of the OER catalyst present in the anode likewise feature a particularly good and enduringly high power density, not least on account of a reduced tendency for corrosion. Resistance to hydrogen reduction even under conditions of startup/shutdown cycles and tolerance to cell reversal even under fuel starvation are exceptionally high.

We also provide a process of producing an oxygen evolution reaction catalyst. The process initially comprises a step a) of heat treating an oxide of iridium and/or an oxide of ruthenium and/or mixtures of these oxides and/or alloys thereof and at least one valve metal oxide selected from oxides of titanium, oxides of niobium, oxides of tungsten and oxides of tantalum at a temperature of at least 900° C. to obtain a solid solution of at least one valve metal oxide and at least one noble metal oxide. The solid solution has the feature that no valve metal oxides or noble metal oxides are additionally present as crystalline phases, this being determinable by x-ray diffraction experiments. It is therefore a real solid solution where the valve metal oxide is completely dissolved in the solid metal oxide and where the composition thereof is derivable from the phase diagram of the employed oxides. The combination of valve metal oxide and noble metal oxide affords a high-performance OER catalyst having very good stability towards reduction by hydrogen.

The upper limit of the temperature employed in this process step may be up to about 1100° C. when using iridium as noble metal and up to about 1450° C. when using ruthenium in the absence of iridium. However, at temperatures markedly there above iridium oxide/ruthenium oxide have a tendency for decomposition. The higher the employed temperature, the higher the energy consumption in the process and therefore temperatures of more than 900° C. to about 1050° C. for iridium oxide-containing systems and of more than 900° C. to about 1300° C. for ruthenium oxide-containing systems are particularly advantageous having regard to obtaining a reduction-stable solid solution of valve metal oxide and noble metal oxide at the lowest possible energy cost.

The abovementioned heat treating affords a real solid solution and not only a partial solid solution of valve metal oxide and noble metal oxide but the specific surface area thereof is inadequate for applications as an efficient OER catalyst such as, for example, in fuel cells. This is attributable especially to the particle growth and the associated collapse of the microstructure. Our process accordingly provides a step b) of grinding the obtained solid solution. The grinding must be carried out by a suitable grinding process which allows comminution of the relatively hard solid solutions and does not only effect deagglomeration of solid solution agglomerates. The grinding is therefore especially effected by high-energy grinding. The grinding increases the BET specific surface area of the solid solution, thus markedly increasing the catalytic activity of the solid solution. Suitable apparatuses for performing the grinding are in particular those which produce an average particle size of less than 100 nm such as, for example, grinding media mills. These include, for example, ball mills, stirred media mills, stirrer mills, attritors and specific roller mills.

The grinding thus produces a BET specific surface area such as is necessary for catalytic applications. After grinding, the BET specific surface area is in particular more than 10 m²/g and preferably more than 20 m²/g. The degree of grinding and thus the upper limit of the BET-specific surface area of the oxygen evolution reaction catalyst is not specifically limited but is preferably not more than 150 m²/g for reasons of simplified production of such a surface area.

The subsequent step c) of heat treating makes it possible to still further improve the reduction stability towards hydrogen. It is thought that this is due to the solid solution being very highly comminuted in the second heat treating step. This renewed heat treating of the ground solid solution is performed at a temperature of 250° C. to 500° C. Agglomeration or caking no longer occurs after grinding and therefore the relatively moderate temperatures in this third process step can once more markedly increase the reduction stability towards hydrogen without sacrificing catalytic surface area.

The process affords an oxygen evolution reaction catalyst featuring very good catalytic performance and a weight loss of less than 2% by weight upon exposure of the oxygen evolution reaction catalyst to a 3.3 vol % hydrogen stream in argon at a temperature of 80° C. for 12 hours.

Advantageously, the heat treating in step c) is performed at a temperature of 350° C. to 450° C. This results in an OER catalyst having particularly high hydrogen reduction stability coupled with excellent catalytic performance.

The BET specific surface area is particularly readily adjustable through grinding using a ball mill or using a planetary ball mill. These grinding apparatuses have a very high energy input which is particularly suitable for comminution of the solid solution.

Having regard to formation of a “real” solid solution without crystalline co-phases of noble metal oxide and/or valve metal oxide the process advantageously comprises a step a1) after the heat treating in step a) and before the grinding in step b), wherein step a1) comprises quenching the obtained solid solution. “Quenching” means strong cooling in air, in particular to room temperature (about 20° C. to 25° C.).

It is further advantageous when a step a2) is performed after step a1), wherein step a2) comprises performing a mechanical mixing of the obtained solid solution which has an advantageous effect on the homogeneity of the solid solution.

In light of the above advantages, steps a), a1) and a2) are in particular repeated at least three times before proceeding with step b).

The process further advantageously comprises a step of supporting the oxygen evolutionary action catalyst on a support material, wherein the support material is in particular a carbon-based support material and especially graphitized carbon or acetylene-based carbon. The step of supporting is performed in particular during or after performance of process step b).

We also provide the use of an oxygen evolution reaction catalyst, wherein the oxygen evolution reaction catalyst comprises a solid solution of at least one valve metal oxide and at least one noble metal oxide, wherein the valve metal oxide is selected from oxides of titanium, oxides of niobium, oxides of tungsten and oxides of tantalum and wherein the noble metal oxide is selected from oxides of iridium, oxides of ruthenium and/or mixtures and/or alloys thereof. The OER catalyst exhibits a weight loss of less than 2% by weight upon exposure of the oxygen evolution reaction catalyst to a 3.3 vol % hydrogen stream in argon at a temperature of 80° C. for 12 hours. The use provides for the use of the OER catalyst in an anode for a fuel cell.

Further details, advantages, and features will be apparent from the following description of examples with reference to the drawings.

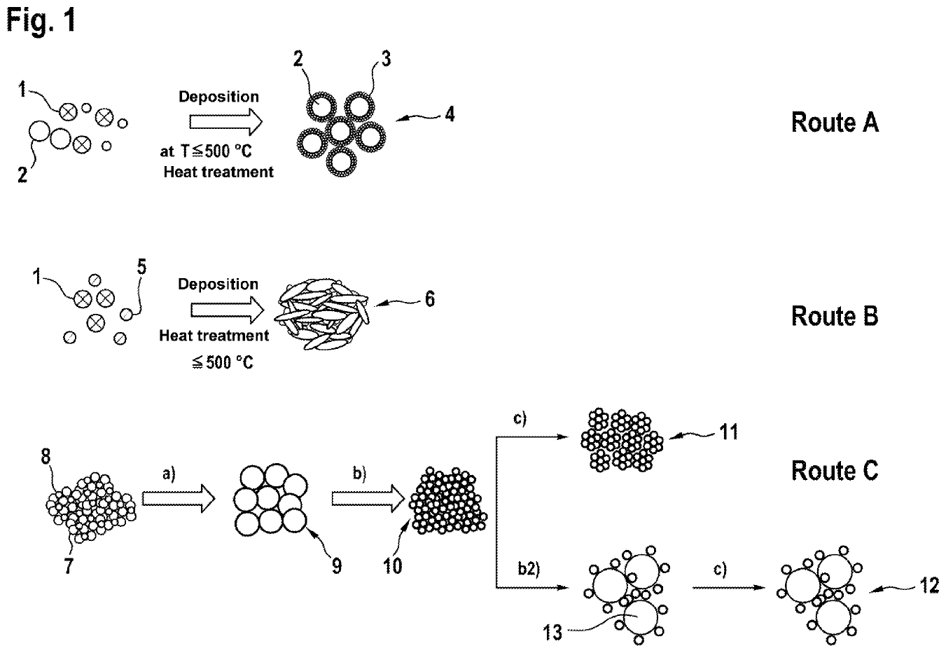

FIG. 1 shows in detail three different processes of producing OER catalysts. Route A shows a conventional process, in which typically a noble metal precursor 1 (for example, an iridium salt) is deposited on a valve metal oxide 2 as support material and then heat treated at low temperatures of about 300° C. to 500° C. The noble metal such as, for example, iridium oxide 3 thus covers the surface of the valve metal oxide 2. However, the OER catalyst 4 obtained according to route A does not feature a sufficiently high reduction stability towards water due to the noble metal, iridium oxide in the present example, and the valve metal oxide being present in the form of two separate phases.

Route B is likewise a conventional process and shows a coprecipitation of a noble metal precursor 1 and a valve metal oxide precursor 5 with subsequent heat treatment also at low temperatures of about 300° C. to 500° C. An OER catalyst having a composite structure 6 or in the form of a partial solid solution is obtained.

Route C represents a process according to one our examples. It comprises a process step a) of heating a mixture 7 of an oxide of iridium and/or an oxide of ruthenium and/or mixtures of these oxides and/or alloys thereof and at least one valve metal oxide 8 selected from oxides of titanium, oxides of niobium, oxides of tungsten and oxides of tantalum at a temperature of at least 900° C. This forms a solid solution 9 of at least one valve metal oxide 8 and at least one noble metal oxide 7. This is followed in process step b) by grinding the obtained solid solution 9, in particular a high-energy grinding with a grinding media mill, for example, a ball mill, a stirred media mill, a stirrer mill, attritors or a specific roller mill. This affords a solid solution 10 having a high BET specific surface area of more than 10 m²/g. This may then be subjected to renewed heat treating in process step c) at a temperature of 250° C. to 500° C. to obtain the pure OER catalyst 11.

In an alternative process mode a process step b2), a supporting on a suitable, usually carbon-based, support material 13 to obtain the OER catalyst 12 supported on a support material 13, may be performed before step c). This forms a supported OER catalyst 12 which likewise features very good reduction stability and very high catalytic activity.

### EXAMPLES

To illustrate the properties of the OER catalyst the following OER catalysts were produced and characterized as specified below, wherein in the characterization reference is made to the accompanying figures and the description thereof. Unless otherwise stated reported quantities are in % by weight.

### Production of OER Catalysts with High Stability Towards Reduction by Hydrogen and High BET Specific Surface Area

### Example 1: Production of a Solid Solution Ti—IrO₂ OER Catalyst (Ir:Ti=8:2)

IrO₂ was produced from IrCl₃·xH₂O by slow basic hydrolysis at room temperature (RT). The hydrolysis was carried out by stirring a pH 12 solution of IrCl₃·xH₂O (Alfa Aesar, 99.8% by weight metals basis) for 24 h. The pH of the solution was adjusted by adding LiOH. Once the reaction had terminated the precipitate was washed four times with boiling water, filtered and dried in an oven at 70° C. The powder was fired in synthetic air at 700° C. for 2 h to obtain heat treated IrO₂.

Thereafter, a stoichiometric ratio of IrO₂ and TiO₂ (Alfa Aesar, 99.7% by weight metals basis) was produced and manually mixed using a mortar and dispersed using ultrasound in an acetone:water (50:50 vol %) solution. The suspension obtained was stirred for 12 h at RT and then centrifuged and the paste obtained was dried at 70° C. in an oven. The powder obtained was pressed in the form of pellets, covered with pure IrO₂ powder and then placed in a tube furnace preheated to 1000° C. with a flow of synthetic air.

After 2 h the mixture was removed from the tube furnace and cooled (quenched) to RT with air. The pellets were then ground initially by hand and then, for homogenization, with a mortar.

The cycle of pellet production, heat treatment and manual mixing was repeated three times to obtain a solid solution of TiO₂ and IrO₂ (ssTi—IrO₂).

The obtained solid solution was ground by mixing a viscous paste of solid solution powder and water with ZrO₂ balls in a ZrO₂ vessel with a planetary stirrer until the obtained BET specific surface area of the ground solid solution was 25 to 35 m²/g.

The resulting powder was subjected to renewed heat treatment at a temperature in a temperature range from 350° C. to 450° C. to obtain the final OER catalyst with high specific surface area (HA-ssTi—IrO₂).

### Example 2: Production of a Solid Solution Ti—IrO₂ OER Catalyst (20% by Weight Ir, Molar Ratio Ir:Ti=8:2)

The Ti—IrO₂ solid solution (ssTi—IrO₂) was produced as per Example 1. After grinding, corresponding amounts of ground powder with graphitized vulcan carbon were added to an acetone/water solution (50:50 vol %) and dispersed in an ultrasonic bath. The suspension obtained was stirred for 12 h at RT and then centrifuged and the paste obtained was dried at 70° C. in an oven.

The resulting powder was subjected to renewed heat treatment at a temperature in a temperature range from 350° C. to 450° C. to obtain the final OER catalyst with high specific surface area (HA-ssTi—IrO₂).

### Example 3: Production of a Solid Solution Ti—IrO₂ OER Catalyst (Molar Ratio Ir:Ti=9:1)

IrO₂ was produced as per Example 1 by slow basic hydrolysis of IrCl₃·xH₂O at RT. A stoichiometric ratio of the obtained IrO₂ and TiO₂ (Alfa Aesar, 99.7% by weight metals basis) was mixed and subjected to heat treatment as per Example 1 to obtain a TiO₂—IrO₂ solid solution (ssTi—IrO₂). The obtained solid solution was wet-ground by mixing a viscous paste of solid solution powder and water with ZrO₂ balls in a ZrO₂ vessel with a planetary stirrer until the obtained BET specific surface area of the ground solid solution was 25 to 35 m²/g.

### Example 4: Production of a Solid Solution Ti—IrO₂ OER Catalyst (20% by Weight Ir, Molar Ratio Ir:Ti=9:1)

The Ti—IrO₂ solid solution (ssTi—IrO₂, molar ratio Ir:Ti=9:1) was produced as per Example 3. After grinding, corresponding amounts of ground powder with graphitized vulcan carbon were added to an acetone/water solution (50:50 vol %) and dispersed in an ultrasonic bath. The suspension obtained was stirred for 12 h at RT and then centrifuged and the paste obtained was dried at 70° C. in an oven.

The resulting powder was subjected to renewed heat treatment at a temperature in a temperature range from 350° C. to 450° C. to obtain the final OER catalyst with high specific surface area (HA-ssTi—IrO₂/C).

### Example 5: Production of a Solid Solution Ti—RuO₂ OER Catalyst (Molar Ratio Ru:Ti: See Table 1)

A stoichiometric ratio of RuO₂ (Alfa Aesar, 99.95% by weight metals basis) and TiO₂ (Alfa Aesar, 99.7% by weight metals basis) was produced and manually mixed using a mortar and dispersed using ultrasound in an acetone:water (50:50 vol %) solution. The suspension obtained was stirred for 12 h at RT and then centrifuged and the paste obtained was dried at 70° C. in an oven. The powder obtained was pressed in the form of pellets, covered with pure RuO₂ powder and then placed in a tube furnace preheated to 1300° C. with a flow of synthetic air.

After 2 h, the mixture was removed from the tube furnace and cooled (quenched) to RT with air. The pellets were then ground initially by hand and then, for homogenization, with a mortar.

The cycle of pellet production, heat treatment and manual mixing was repeated three times to obtain a solid solution of TiO₂ and RuO₂ (ssTi—RuO₂).

The obtained solid solution was wet-ground by mixing a viscous paste of solid solution powder and water with ZrO₂ balls in a ZrO₂ vessel with a planetary stirrer until the obtained BET specific surface area of the ground solid solution was 25 to 45 m²/g.

The resulting powder was subjected to renewed heat treatment at a temperature in a temperature range from 350° C. to 450° C. to obtain the final OER catalyst with high specific surface area (HA-ssTi—RuO₂).

### Example 6: Production of a Solid Solution Nb—RuO₂ OER Catalyst (Molar Ratio Ru:Nb: See Table 1)

A stoichiometric ratio of RuO₂ (Alfa Aesar, 99.95% by weight metals basis) and NbO₂ (Alfa Aesar, 99.9985% by weight metals basis) was produced and manually mixed using a mortar and dispersed using ultrasound in an acetone:water (50:50 vol %) solution. The suspension obtained was stirred for 12 h at RT and then centrifuged and the paste obtained was dried at 70° C. in an oven. The powder obtained was pressed in the form of pellets, covered with pure RuO₂ powder and then placed in a tube furnace preheated to 1300° C. with a flow of synthetic air.

After 2 h, the mixture was removed from the tube furnace and cooled (quenched) to RT with air. The pellets were then ground initially by hand and then, for homogenization, with a mortar.

The cycle of pellet production, heat treatment and manual mixing was repeated three times to obtain a solid solution of Nb₂O₅ and RuO₂ (ssNb—RuO₂).

The obtained solid solution was wet-ground by mixing a viscous paste of solid solution powder and water with ZrO₂ balls in a ZrO₂ vessel with a planetary stirrer until the obtained BET specific surface area of the ground solid solution was 25 to 45 m²/g.

The resulting powder was subjected to renewed heat treatment at a temperature in a temperature range from 350° C. to 450° C. to obtain the final OER catalyst with high specific surface area (HA-ssNb—RuO₂).

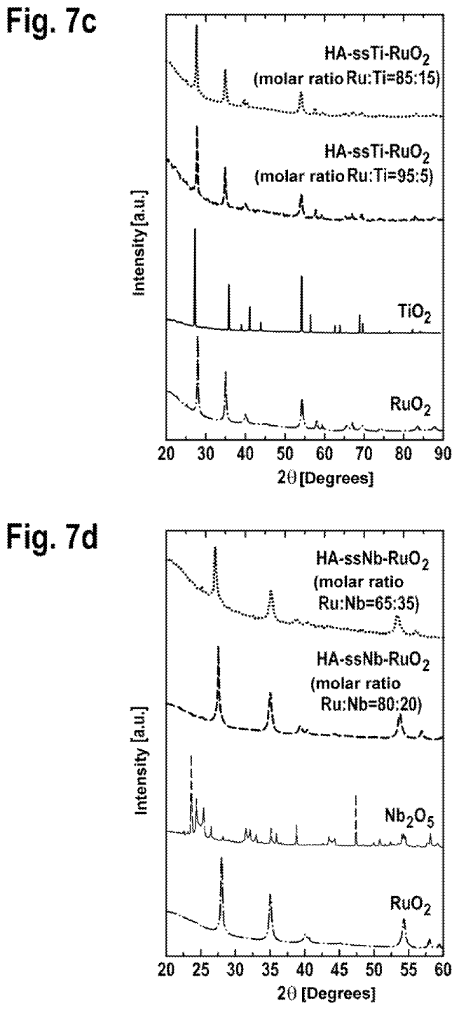

FIGS. 7a-7d and Table 1 show the specification and characteristic stability information of different RuO₂-based solid solutions.

Table 1 is a summary of RuO₂ solid solution samples and the characteristic stability thereof in H₂ atmosphere measured by TGA (see FIG. 7a for further elucidations on stability). HA samples were ground and subjected to heat treatment.

TABLE 1

| | | Ru:Ti or Ru:Nb | Temperature at 2% |
|---|---|---|---|
| Sample | Sample type | molar ratio | weight loss [° C.] |
| R1 | RuO₂ | — | 152 |
| R2 | HA-RuO₂ | — | 119 |
| R3 | ssTi-RuO₂ | 95:5 | 189 |
| R4 | ssTi-RuO₂ | 85:15 | 218 |
| R5 | ssTi-RuO₂ | 75:25 | 220 |
| R6 | ssTi-RuO₂ | 50:50 | 220 |
| R7 | HA-ssTi-RuO₂ | 85:15 | 160 |
| R8 | ssNb-RuO₂ | 95:5 | 191 |
| R9 | ssNb-RuO₂ | 80:20 | 280 |
| R10 | ssNb-RuO₂ | 75:25 | 303 |
| R11 | ssNb-RuO₂ | 65:35 | |
| R12 | ssNb-RuO₂ | 50:50 | 410 |
| R13 | HA-ssNb-RuO₂ | 65:35 | 182 |
| R14 | HA-ssNb-RuO₂ | 50:50 | 338 |

### Characterization of OER Catalysts

### X-Ray Diffraction

X-ray diffraction experiments were performed using a Stadi P instrument (Stoe & Cie GmbH) mit CuK_{α1} radiation (λ=1.54059 Å, 50 kV, 30 mA, Ge(111) monochrome) and a Mythen 1K areal detector (Dectris Lts., Switzerland) in transmission mode.

About 5 mg of a pulverulent OER catalyst sample was gently spread on an adhesive tape and fixed in the center of a sample holder hole. The XRD pattern was recorded at a 2θ angle, in the range from 20° to 90° in 0.127° steps and with a holding time of 20 seconds per step. Thermogravimetric measurement (TGA)

Thermogravimetric analysis in a reductive atmosphere (3.3 vol % H₂/Ar) was used to determine the reduction stability of the OER catalysts. The oxide reduction by H₂ according to:

IrO_{2(S)}+2H_{2(g)}->Ir_{(S)}+2H₂O_{(g)} or

RuO_{2(S)}+2H_{2(g)}->Ru_{(S)}+2H₂O_{(g)}

was monitored by recording the mass loss of a sample during the TGA experiment.

The reduction stability of the catalysts was determined by measurement of the mass loss/weight loss of the OER catalyst according to the modes set out below (temperature ramp experiment and isothermal mode) using a hydrogen flow at elevated temperature. To this end the thermogravimetric analysis (TGA) was performed in a reductive atmosphere. The isothermal experiments were performed to determine the time to reduction of a catalyst under simulated PEMFC anode conditions (T=80° C.).

The thermogravimetric analysis of the OER catalyst powder was performed using a Mettler Toledo TGA/DSC 1 apparatus. About 10 to 12 mg of the OER catalyst powder were placed in a corundum crucible (volume: 70 μL) and sealed with a perforated corundum lid and placed directly in the TGA furnace. All gases used in the thermogravimetric analysis were of 5.0 purity and obtainable from Westfalen AG. Argon (20 mLmin⁻¹) was used as a cell carrier gas in addition to hydrogen.

Each TGA measurement is divided into steps:
i) an in-situ drying step in oxidizing atmosphere, and
ii) a metal oxide reduction step in a reducing atmosphere.

The in-situ drying step was used to desorb all water molecules and organic molecules adsorbed on the surface of the OER catalyst powder to ensure that the weight loss in step ii) is due only to the reduction of iridium oxide.

The in-situ drying step was performed as follows: initially the TGA furnace is purged with argon for 5 min at a temperature of 25° C. (100 mLmin⁻¹), subsequently the temperature is ramped up from 25° C. to 200° C. (10 Kmin⁻¹) in O₂ (100 mLmin⁻¹). The temperature of 200° C. is held for 10 min in O₂ (100 mLmin⁻¹). The furnace was then cooled from 200° C. to 25° C. (−10 Kmin⁻¹) in O₂ (100 mLmin⁻¹) and finally the TGA furnace was purged with argon (100 mLmin⁻¹) for 5 min at 25° C.

The metal oxide reduction step was performed according to two different modes: a) a temperature ramp mode, and b) an isothermal mode.

Depending on the employed noble metal (iridium and/or ruthenium) different temperature ramps were run in performance in the temperature ramp mode. The temperature of the furnace was increased from 25° C. to 500° C. if iridium was present as noble metal and from 25° C. to 800° C. if ruthenium was present as noble metal in the absence of iridium in each example at a heating rate of 5 Kmin⁻¹ in 3.3 vol % H₂/Ar (40 mLmin⁻¹) followed by cooling of the furnace to 25° C. (cooling rate: −20 Kmin⁻¹) in argon (100 mLmin⁻¹).

In a performance in the isothermal mode the furnace is heated from 25° C. to 80° C. with a heating rate of 5 Kmin⁻¹ in argon (100 mLmin⁻¹) followed by gas switchover to 3.3 vol % H₂/Ar (40 mLmin⁻¹) and held at 80° C. for 12 hours. Thereafter the furnace was cooled from 80° C. to 25° C. (cooling rate: −20 Kmin⁻¹) in Ar (100 mLmin⁻¹).

The weight loss during the TGA experiment was attributable to the reduction in IrO₂/RuO₂ to metallic Ir/Ru by H₂ according to the following reactions:

IrO₂(s)+2H₂(g)→Ir(s)+2H₂O(g)

RuO₂(s)+2H₂(g)→Ru(s)+2H₂O(g).

We demonstrated that the heat treatment in step a) of our process and the resulting production of a solid solution markedly increased the stability of the obtained OER catalyst towards reduction by hydrogen.

The BET surface area was determined using a Quantachrome Autosorb iQ instrument. The samples are degassed overnight at 120° C. and the N₂-Adsorption was measured at 77 K. The specific surface area (BET specific surface area) was determined according to Brunauer-Emmett-Teller (BET) theory using “mircopore BET assistant” of the software AsiQwin.

### Ex-Situ OER Activity Measurements

Ex-situ OER activity measurements were performed using a water-jacketed three-electrode cell using a reversible hydrogen electrode (RHE) as the reference electrode. A high surface area gold wire was used as the counter electrode and a rotating ring-disk electrode (RRDE) consisting of a polycrystalline gold disk supported on a PTFE body having a diameter of 5 mm was used as the working electrode in 0.1 M aqueous H₂ SO₄ solution as electrolyte.

### CCM Production

Catalyst coated membranes (CCM) were produced from anode catalyst layers containing 20% by weight Pt on graphitized carbon with a platinum loading of 0.05 mg Pt/cm² and cathode catalyst layers containing 50% by weight of a Pt/C catalyst with a platinum loading of 0.30 mg Pt/cm². Catalyst coated membranes (CCMs) were then produced using a decal process (standard decal transfer process), wherein a 15 μm thick perfluorosulfonic acid (PFSA) ionomer membrane was arranged between an anode layer and a cathode layer opposite the anode layer on the other side of the membrane. The active area of both catalyst layers was 71 mm×62 mm and the membrane size was 110 mm×110 mm. Table 2 summarizes the CCM compositions.

### Comparative Example 1 (Without OER Catalyst in the Anode)

An anode catalyst ink was produced by mixing 20% by weight of a Pt/C catalyst in water, solvent and a PFSA ionomer dispersion. The anode catalyst ink was ground for 120 minutes in a ball mill (grinding medium: 1 mm diameter ZrO₂ balls). An anode catalyst layer was produced by applying and drying the catalyst ink on a substrate.

A cathode catalyst ink was produced by mixing 50% by weight of a Pt/C catalyst, water, solvent and a PFSA ionomer dispersion. The cathode catalyst ink was ground for 120 minutes in a ball mill (grinding medium: 1 mm diameter ZrO₂ balls). A cathode catalyst layer was produced by applying and drying the catalyst ink on a substrate.

The catalyst layers were combined with a membrane to afford a CCM using a standard decal process. The active area of both catalyst layers was 71 mm×62 mm and the membrane size was 110 mm×110 mm.

### Comparative Example 2 (Conventional OER Catalyst in the Anode)

An anode catalyst ink was produced by mixing 20% by weight of a Pt/C catalyst oxide with iridium powder (Pt to Ir weight ratio: 1:1). The iridium oxide powder used was Elyst Ir75 0480 from Umicore, a commercial catalyst powder, wherein the IrO₂ is supported on TiO₂. The OER catalyst was mixed with a Pt/C catalyst dispersion and thoroughly ground in a ball mill for 120 minutes (grinding medium: 1 mm diameter ZrO₂ balls).

A cathode catalyst layer was produced as per Comparative Example 1.

The catalyst layers were combined with a membrane to afford a CCM using a standard decal process. The active area of both catalyst layers was 71 mm×62 mm and the membrane size was 110 mm×110 mm.

### Example 7

An anode catalyst layer was produced by mixing a Pt/C catalyst with iridium oxide powder (Pt to Ir weight ratio: 1:1). The produced iridium oxide powder was mixed with a Pt/C catalyst dispersion and thoroughly ground in a ball mill for 120 minutes (grinding medium: 1 mm diameter ZrO₂ balls).

A cathode catalyst layer was produced as per Comparative Example 2.

The catalyst layers were combined with a membrane to afford a CCM using a standard decal process. The active area of both catalyst layers was 71 mm×62 mm and the membrane size was 110 mm×110 mm.

Table 2 provides an overview of the CCM compositions produced.

TABLE 2

| | | Cathode | | | Anode | Anode |
|---|---|---|---|---|---|---|
| | | Pt loading | Anode | Anode | Pt loading | Ir loading |
| | Cathode | (mg cm⁻²) | Pt/C cat. | OER cat. | (mg cm⁻²) | (mg cm⁻²) |
| Comparative | 50% by | 0.30 | 20% by | — | 0.05 | 0.00 |
| Example 1 | wt. Pt/C | | wt. Pt/C | | | |
| Comparative | 50% by | 0.30 | 20% by | Elyst Ir75 | 0.05 | 0.05 |
| Example 2 | wt. Pt/C | | wt. Pt/C | 0480 | | |
| Example 7 | 50% by | 0.30 | 20% by | Inventive | 0.05 | 0.05 |
| | wt. Pt/C | | wt. Pt/C | OER catalyst | | |

### Fuel Cell Test

Electrochemical tests were performed using a 38 cm² PEM single cell fitted with graphitized serpentine flow plates. The single cell was under thermal control, wherein heat-resistant heating plates were used for heating and a ventilator was used for air cooling. The gases were humidified using a bubbler. The single cell was run in countercurrent.

All CCMs produced were provided with carbon-based gas diffusion layers on both sides of the membrane electrode units (CCMs). All CCM samples were fitted with non-compressible glass fiber reinforced PTFE seals, thus resulting in a 10 vol % compression of the GDL. Prior to performing the performance tests on the MEA samples, the single cell was conditioned under hydrogen/air for 8 hours at 1 A/cm² and a pressure of 1.5 bar_{abs}. The temperature of the single cell T_{cell} was 80° C. and the humidifier temperatures were 80° C. (anode) and 80° C. (cathode).

Hydrogen/air IV polarization measurements were performed at the beginning of life (BOL), during the startup/shutdown cycle test and at the end of test (EOT), specifically under the following conditions: T_{cell}=80° C., humidifier temperature=80° C. (both sides), pressure=1.5 bar_{abs}, anode stoichiometry=1.5, cathode stoichiometry=2.

### Corrosion Tests

During fluctuating conditions a fuel cell may be subjected to high potentials. These conditions include air/air startup/shutdown (current reversal) and fuel starvation (cell reversal) which were simulated using the following tests.

### Startup/Shutdown Cycle Test (SUSD)

SUSD cycles were simulated in a gas exchange experiment with defined residence times of the hydrogen/air front. The anode side of the single cell was equipped with three-way valves that allowed switching between dry air and humidified hydrogen. To simulate startup the anode flow field was initially filled with dry air which was then replaced with humidified hydrogen to form an H₂/air front. By contrast, during shutdown the anode flow field filled with humidified hydrogen was purged with dry air to form an air/H₂ front.

Operating conditions were kept constant in both compartments during the SUSD experiments (1.01 bar_{abs}, outlet and 100% relative humidity RH). The residence time of the H₂/air front in the single cell was defined as the flow field volume (cm³) divided by the volume flow of humidified gas under SUSD conditions (35° C. and 1.01 bar_{abs}, outlet) and was set at 0.3 seconds. The time between startup and shutdown was set to 55 seconds. Polarization curves were recorded immediately after conditioning of the MEA and after each set of 10, 40, 50, 100, 300 and 500 SUSD cycles to observe the voltage loss at a reference condition of 80° C.

### Fuel Starvation Test (Cell Reversal)

The cells were subjected to an extended voltage reversal test which consisted of drawing a current of 0.2 A/cm² while the fuel cell was operated with air on the cathode side and nitrogen on the anode side (this simulates the fuel starvation example). The end of the test was reached when the average cell voltage fell below −1.5 V. The time required to reach −1.5 V was calculated as the extended reversal tolerance time.

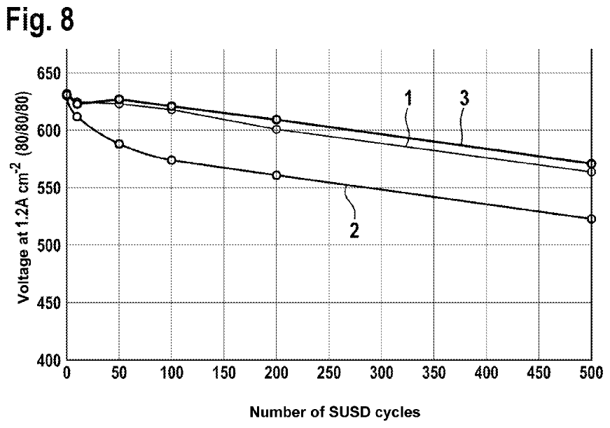

The results of the electrochemical tests are shown in FIG. 8 and in Table 3.

Table 3 provides a detailed overview of the functionality of the CCMs.

TABLE 3

| | Performance BOL/ | Degradation during SUSD/ | CRT time loss |
|---|---|---|---|
| | mV at 1.2 A/cm² | mV loss per 500 cycles | [%] |
| Comparative | 632 | 68 | no CRT capacity |
| Example 1 | | | |
| Comparative | 630 | 107 | 68% |
| Example 2 | | | |
| Example 7 | 631 | 60 | 17% |

It is apparent from Table 3 that all CCMs have the same performance at beginning of life (BOL) and so the OER catalyst does not affect these values.

However, degradation over time is apparent. Degradation is high for the comparative examples in particular.

The CRT time loss indicates the percentage loss of MEA reversal test time once the MEA has been subjected to the SUSD test. The MEA comprising the conventional OER catalyst lost most of their CRT capability as a result of the OER catalyst dissolving during the SUSD test. The MEA (Example 7) retained most of its CRT capability.

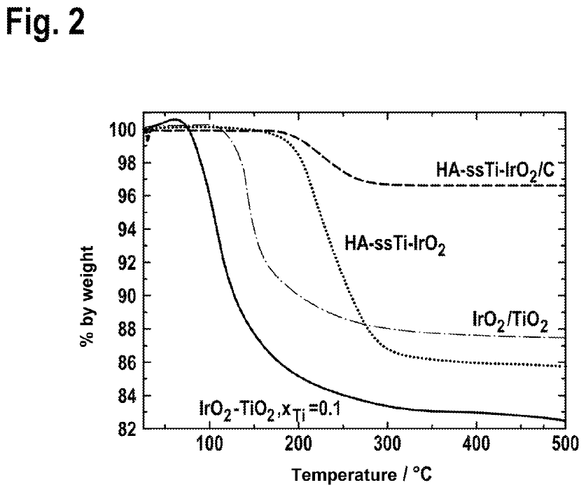

FIG. 2 shows results of TGA temperature ramp experiments in 3.3 vol % H₂/Ar to determine the stability of IrO₂ and TiO₂ mixtures produced according to routes A, B and C from FIG. 1. IrO₂/TiO₂ (75% by wt. Ir, Elyst Ir75 0480 from Umicore, Germany) is a commercially available OER catalyst produced according to route A. IrO₂—TiO₂, X(Ti)=0.1 is an OER catalyst produced according to route B, wherein X(Ti) describes the molar proportion of titanium calculated as Ti/(Ti+Ir). HA-ssTi—IrO₂/C is the OER catalyst produced according to Example 4 (route C) and HA-ssTi—IrO₂ is the OER catalyst produced according to Example 3 (Route C). The efficient interaction between TiO₂ and IrO₂ in HA-ssTi—IrO₂ and HA-ss—Ti—IrO₂/C had a great influence on the non-reproducibility of IrO₂ and the most stable catalysts in a reductive atmosphere among all samples produced according to the different routes from FIG. 1 were thus obtained.

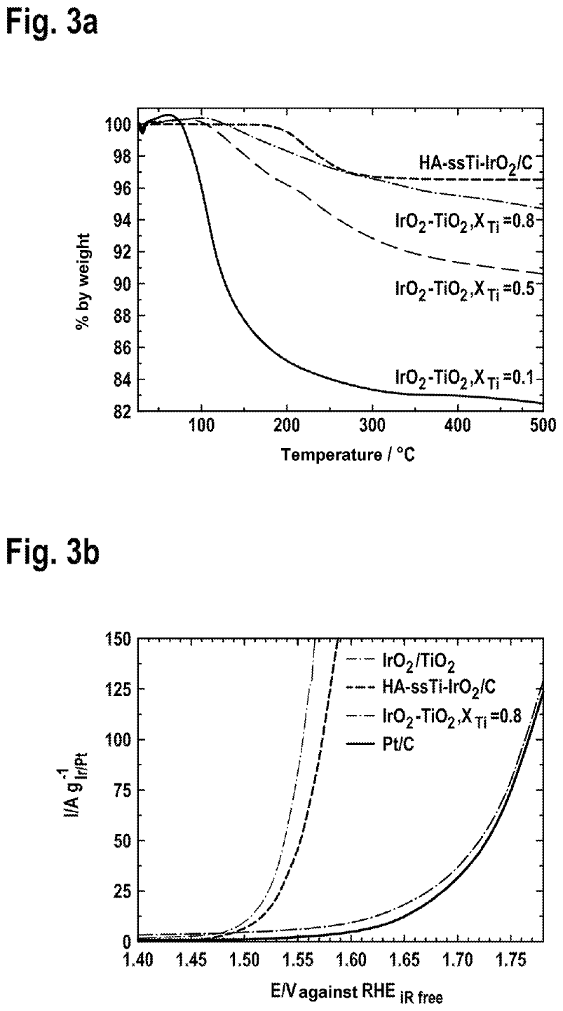

FIG. 3a shows results of temperature ramp experiments in 3.3 vol % H₂/Ar to illustrate the stability of IrO₂—TiO₂ mixtures with X(Ti), wherein X=0.1, 0.5 and 0.8, wherein the mixtures were produced according to Route B in FIG. 1, wherein X(Ti) describes the molar proportion of titanium calculated as Ti/(Ti+Ir). It is apparent that there was a direct correlation between the stability of the samples in a reductive atmosphere and the amount of TiO₂ in the samples. One reason for this could be that the IrO₂ is covered by TiO₂.

A typical characteristic of solid solution OER catalysts is also shown in FIG. 3a (HA-ssTi—IrO₂/C, Example 4). Even the IrO₂—TiO₂ sample with X(Ti)=0.8 did not show comparably good reduction stability compared to HA-ssTi—IrO₂/C.

FIG. 3b shows OER polarization curves measured by RDE. Due to the possible physical covering of IrO₂ by TiO₂ in IrO₂—TiO₂ X(Ti)=0.8, the OER activity of this sample suffered since it showed a comparatively lower activity compared to the IrO₂/TiO₂ and HA-ssTi—IrO₂ samples. The OER activity of IrO₂—TiO₂ X(Ti)=0.8 was accordingly comparable to Pt/C catalysts and was therefore not an efficient catalyst for fuel starvation applications.

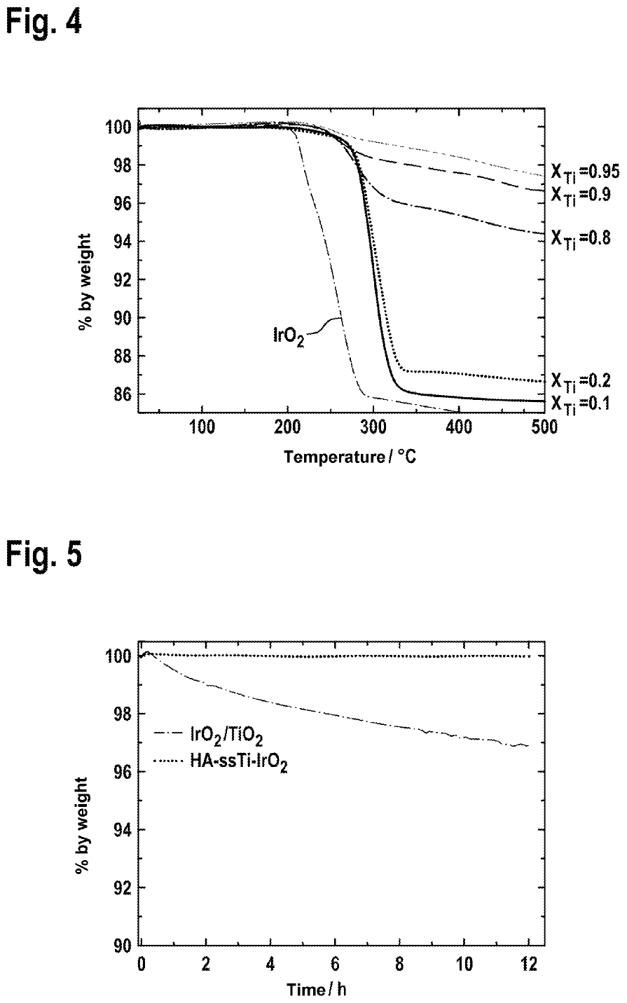

FIG. 4 shows the results of TGA temperature ramp experiments in 3.3 vol % H₂/Ar for synthesized solid solutions, ssTi—IrO₂ where X(Ti)=0.1, 0.2, 0.8, 0.9 and 0.95, produced according to the procedure of Example 1. It is apparent from FIG. 4 that the stability of the real solid solutions in a reductive atmosphere was independent of the amount of TiO₂ in the initial mixture since all real solid solutions began to undergo reduction at the same temperature (about 250° C.) and showed the same amount of improved stability relative to pure fired IrO₂ at the same temperature (1000° C.).

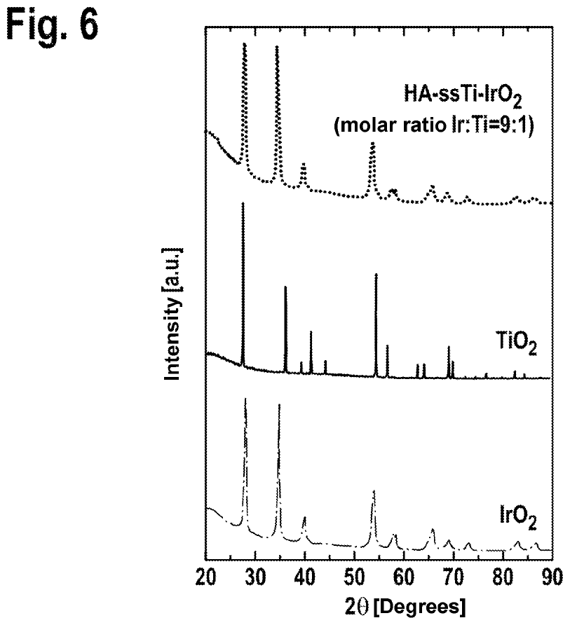

FIG. 5 shows an isothermal mode experiment at 80° C. in 3.3 vol % H₂/Ar on IrO₂/TiO₂ and HA-ssTi—IrO₂ (Example 3) to illustrate the stability of the samples in a simulated chemical environment of a PEMFC anode. It is apparent from FIG. 5 that after 12 h the IrO₂/TiO₂ catalyst showed a weight loss of 3.2% by weight which corresponded to a reduction of about 24.8% by weight of IrO₂ to metallic Ir in this sample. By contrast, the ssTi—IrO₂ solid solution was stable over the entire 12-hour experiment.

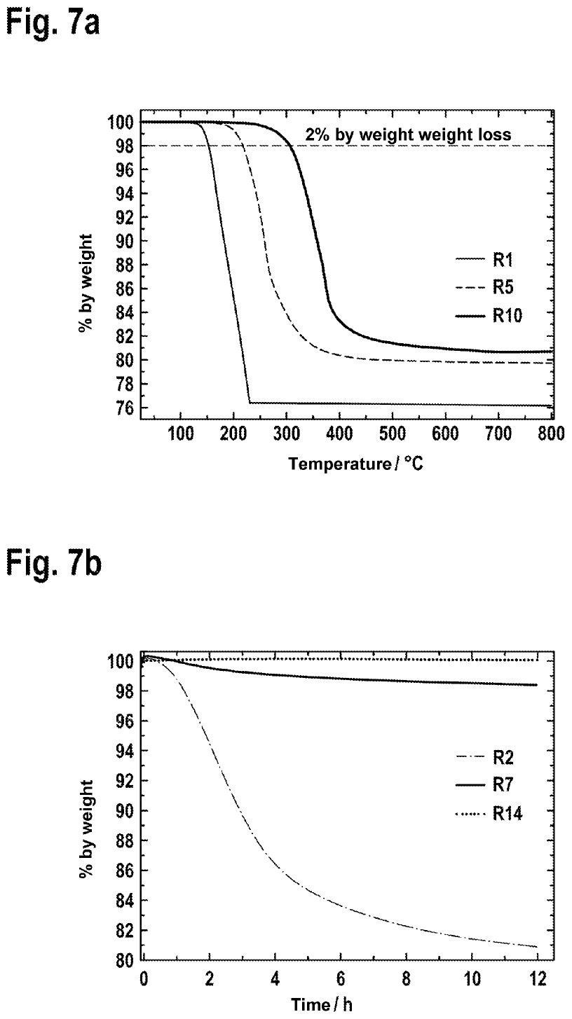

FIG. 6 shows XRD patterns of TiO₂, IrO₂ and HA-ssTi—IrO₂ (molar ratio Ir:Ti=9:1). The pattern of HA-ssTi—IrO₂ did not show any crystal reflections of TiO₂ all reflections in the HA-ssTi—IrO₂ XRD pattern corresponded to IrO₂ reflections. This demonstrated that TiO₂ is completely dissolved in IrO₂ as the host crystal structure and is therefore evidence of a true solid solution. No free TiO₂ crystal/particle was available in HA-ssTi—IrO₂ after the inventive formation of the solid solution. This is apparent from the 20 values of the (110) reflection peaks of the rutile IrO₂ and TiO₂ structures:

IrO2=27.92°

TiO₂=27.42°

HA-ssTi—IrO₂=27.80°.

FIG. 7a shows results of temperature ramp experiments in 3.3 vol % H₂/Ar on the real solid solutions synthesized, ssTi—RuO₂ and ssNb—RuO₂ (details of these samples may be found in Table 1), produced by the production procedure in Examples 5 and 6. R1 is pure RuO₂, heat treated for 2 h at 1300° C. in air. It is apparent from FIG. 7a that the solid solutions were more stable in a reductive atmosphere than RuO₂ (R1). The temperatures at which the samples showed reductions and showed a weight loss of 2% by weight (see dashed line) in Table 1 are to be regarded as measured results of sample stabilities in a reductive atmosphere.

FIG. 7b shows results of isothermal mode experiments at 80° C. in 3.3 vol % H₂/Ar to demonstrate the stability of samples in a simulated chemical environment of a PEMFC anode. R2 is an RuO₂ having a high specific surface area produced from R1 by grinding with a ball mill and subsequent heat treatment as described in Examples 5 and 6. It is apparent from FIG. 7b that after 12 h R1 showed a weight loss of 19.1% by weight which corresponded to a reduction of about 80% by weight of the employed RuO₂ to metallic Ru in this sample. R7 was more stable than R2 and showed a weight loss of only 1.6% by weight after 12 h which corresponded to a reduction of about 8% by weight of the RuO₂ to metallic Ru in this sample. R14 was completely stable over the entire 12 hour experiment.

FIG. 7c shows XRD patterns of RuO₂, TiO₂, HA-ssTi—RuO₂ (molar ratio Ru:Ti=95:5) and HA-ssTi—RuO₂ (molar ratio Ru:Ti=85:15) and FIG. 7d shows XRD patterns of RuO₂, Nb₂O₅, HA-ssNb—RuO₂ (molar ratio Ru:Nb=80:20) and HA-ssNb—RuO₂ (molar ratio Ru:Nb=65:35). The XRD patterns of the HA-ssTi—RuO₂ and HA-ssNb—RuO₂ samples did not show any reflections from TiO₂ and Nb₂O₅ and all reflections were attributable to RuO₂. This demonstrated that TiO₂ and Nb₂O₅ were completely dissolved in RuO₂ as the host crystal structure and is therefore evidence of a true solid solution. No free TiO₂ or Nb₂O₅ crystal/particle was available in HA-ssTi—IrO₂ and HA-ssNb—RuO₂ after the inventive formation of the solid solution. This is apparent from the 2θ values of the (110) reflection peaks of the rutile RuO₂ and TiO₂ structures:

RuO₂=28.06°

TiO₂=27.42°

HA-ssTi—RuO₂ (Ru:Ti=95:5)=27.99°

HA-ssTi—RuO₂ (Ru:Ti=85:15)=27.96°

and from the 2θ values of the (110) reflection peaks of the rutile ssNb—RuO₂ structure:

HA-ssNb—RuO₂ (Ru:Nb=80:20)=27.61°

HA-ssNb—RuO₂ (Ru:Nb=65:35)=27.25°

and from the 2θ value of the strongest reflection peak of Nb₂O₅: 23.72°.

FIG. 8 shows the MEA performance loss during the SUSD cycle test. Curve 1 shows the MEA of Comparative Example 1 (no OER catalyst), curve 2 shows the MEA of Comparative Example 2 (conventional OER catalyst) and curve 3 shows the MEA of Example 7 (invention). It is apparent from FIG. 8 that in this test the MEA comprising the conventional OER catalyst underwent much faster decomposition. During the SUSD cycle test the unstable OER catalyst dissolved and generated free Ir which is a cathode poison for the MEA. By contrast, our MEA is more resistant to decomposition than the MEA without an OER catalyst.

In addition to the above written description, explicit reference is hereby made to the graphical representation in FIGS. 1 to 8 for the supplementary disclosure thereof.

1-12. (canceled)

13. An oxygen evolution reaction catalyst comprising a solid solution of at least one valve metal oxide and at least one noble metal oxide,
wherein the valve metal oxide is selected from oxides of titanium, oxides of niobium, oxides of tungsten and oxides of tantalum,
the noble metal oxide is selected from oxides of iridium, oxides of ruthenium and/or mixtures and/or alloys thereof,
the BET specific surface area of the solid solution is greater than 10 m²/g, and
the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

14. The oxygen evolution reaction catalyst as claimed in claim 13, wherein the BET specific surface area of the solid solution is greater than 20 m²/g.

15. The oxygen evolution reaction catalyst as claimed in claim 13, wherein the oxygen evolution reaction catalyst is supported on a support material, and the support material is a carbon-based support material or a graphitized carbon.

16. An anode for a fuel cell comprising an oxygen evolution reaction catalyst comprising a solid solution of at least one valve metal oxide and at least one noble metal oxide, wherein the valve metal oxide is selected from oxides of titanium, oxides of niobium, oxides of tungsten and oxides of tantalum, the noble metal oxide is selected from oxides of iridium, oxides of ruthenium and/or mixtures and/or alloys thereof, and the oxygen evolution reaction catalyst exhibits a weight loss of less than 2% by weight upon exposure of the oxygen evolution reaction catalyst to a 3.3 vol % hydrogen stream in argon at a temperature of 80° C. for 12 hours.

17. An anode for an electrochemical cell comprising the oxygen evolution reaction catalyst as claimed in claim 13.

18. The anode as claimed in claim 16, further comprising at least one hydrogen oxidation catalyst, a platinum-based hydrogen oxidation catalyst,
the hydrogen oxidation catalyst is supported on a support material, on a carbon-based support material or on graphitized carbon, or
the oxygen evolution reaction catalyst is supported on a support material, on a carbon-based support material or on a graphitized carbon, and the hydrogen oxidation catalyst is deposited on the oxygen evolution reaction catalyst and/or on the carrier material.

19. A membrane electrode assembly comprising the anode as claimed in claim 16.

20. A water electrolysis cell comprising the anode as claimed in claim 17.

21. A fuel cell comprising the anode as claimed in claim 16.

22. A process of producing the oxygen evolution reaction catalyst as claimed in claim 13, comprising:
a) heat treating an oxide of iridium and/or an oxide of ruthenium and/or mixtures of these oxides and/or alloys thereof and at least one valve metal oxide selected from oxides of titanium, oxides of niobium, oxides of tungsten and oxides of tantalum at a temperature of at least 900° C. to obtain a solid solution of at least one valve metal oxide and at least one noble metal oxide,
b) grinding the obtained solid solution, and
c) heat treating the ground solid solution at a temperature of 250° C. to 500° C.

23. The process as claimed in claim 22, wherein the heat treating in step c) is performed at a temperature of 350° C. to 450° C. and/or
the grinding in step b) is performed using a ball mill or using a planetary ball mill and/or
further comprising a step a1) after the heat treating in step a) and before the grinding in step b), wherein step a1) comprises quenching the obtained solid solution, wherein a step a2) is performed in particular after step a1), wherein step a2) comprises performing a mechanical mixing of the obtained solid solution, wherein steps a), a1) and a2) are repeated at least three times before proceeding with step b), and/or
comprising before step c) a step b1) of supporting the oxygen evolution reaction catalyst on a support material, wherein the support material is a carbon-based support material or graphitized carbon.
